(19) United States
(12) Patent Application Publication
(10) Pub. No.: US 2003/0222957 A1
(43) Pub. Date: Dec. 4, 2003

(54) Device preventing printers from jam on the jet nozzle

(76) Inventor: Chen Chien Yuan, (US)

Correspondence Address: BRUCE H. TROXELL, 5205 LEESBURG PIKE, SUITE 1404, FALLS CHURCH, VA, 22041, US

(21) Appl. No.: 10/159,019

(22) Filed: Jun. 3, 2002

(51) Int. Cl. B41J 2/175

(52) U.S. Cl. 347/86

(57) ABSTRACT

This invention provides a device preventing printers from jam on the jet nozzle, comprising of a cartridge filled with ink and with an ink outlet contacting the nozzle of printer. It features with: a liquid lighter than and not dissolvable in the ink in the cartridge and an absorbent at the outlet in the said cartridge. Thus, when the ink in the cartridge is used up, the absorbent will absorb the liquid, which prevents both the ink from drying to congregate into a mass and the outlet from drying. Therefore, it can keep the nozzle of printer wet and unblocked. Furthermore, it can also prevent the nozzle from blocking due to the chemical combination between different brands of ink used.

### FIELD OF THE INVENTION

This invention provides a device preventing printers from jam on the jet nozzle, in particular refers to a device simple in structure, easy to implement, and capable of preventing the nozzle of printer from blocking even when the printer is not used for long. This device can reduce failures of the nozzle of printer and prolong the life circle of the printer.

### BACKGROUND OF THE INVENTION

With the progress of our society and the popularization of computers, peripheral equipment of computers booms quickly. Due to its wide application and decreased price, printer becomes a necessity for computer users, and it has evolves from original stylus printer to ink jet printer and laser printer. Among the three types, ink jet printer is the most popular due to its relatively faster speed (when compared with stylus printer), low price of consumable, and color graphic printing capacity. Because that the ink jet printer plots with ink jetted out from the cartridge via its nozzle, the quality of it depends not only on the quality of ink used but also the cleanliness and smooth of the nozzle hole. However, most ink cartridges used in ink jet printers currently has the following shortcomings:

1. When not used for a long time, the ink may dry and form a mass, which will block the nozzle hole and result in degradation of imaging quality, and in some cases, even damage the nozzle.

2. If not used properly, for example, some users may not use the exclusive ink cartridge or refill the cartridge, the ink may be degraded and form a mass, which will block the nozzle hole and even damage the nozzle.

### SUMMARY OF THE INVENTION

In consideration of the above shortcomings of typical cartridges, the inventor invents a device that can prevent printers from jam on the jet nozzle, in particular refers to a device simple in structure, easy to implement, and capable of preventing the nozzle of printer from blocking even when the printer is not used for long. It can reduce failures of the nozzle of printer and prolong the life circle of the printer.

The main purpose of this invention is to provide a device that can prevent printers from jam on the jet nozzle, comprising of a cartridge filled with ink and with an ink outlet contacting the nozzle of printer. It features with: a liquid lighter than and not dissolvable in the ink in the cartridge and an absorbent at the outlet in the said cartridge. Thus, when the ink in the cartridge is used up, the absorbent will absorb the liquid, which prevents both the ink from drying to congregate into a mass and the outlet from drying. Therefore, it can keep the nozzle of printer wet and unblocked.

Another purpose of this invention is to provide a device that can prevent printers from jam on the jet nozzle. The liquid filled in the cartridge of that device is lighter than and not dissolvable in the ink, thus prevents the nozzle of printer from jam due to alternative ink (not original ink) filled in the cartridge.

Another purpose of this invention is to provide a device that can prevent printers from jam on the jet nozzle. The device is tolerant to different brands of ink filled, and can prolong the circle life of the printer.

### BRIEF DESCRIPTION OF THE DRAWINGS

FIG. 1 is a sectional view of this invention;

FIG. 2 is a sectional view of this invention under the condition that the ink is used up.

### INSTRUCTION OF THE REFERENCE NUMBERS

10 Device

11 Cartridge

12 Ink Outlet

13 Ink

14 Liquid

15 Absorbent

20 Nozzle

### DETAILED DESCRIPTION OF THE PREFERRED EMBODIMENT

The additional purposes of this invention will be further clarified through the following description and illustration. Though some parts or arrangement of parts may be slight different in various embodiments of this invention, the embodiments selected hereunder will be detailed to further demonstrate the technical approach and the structure of this invention.

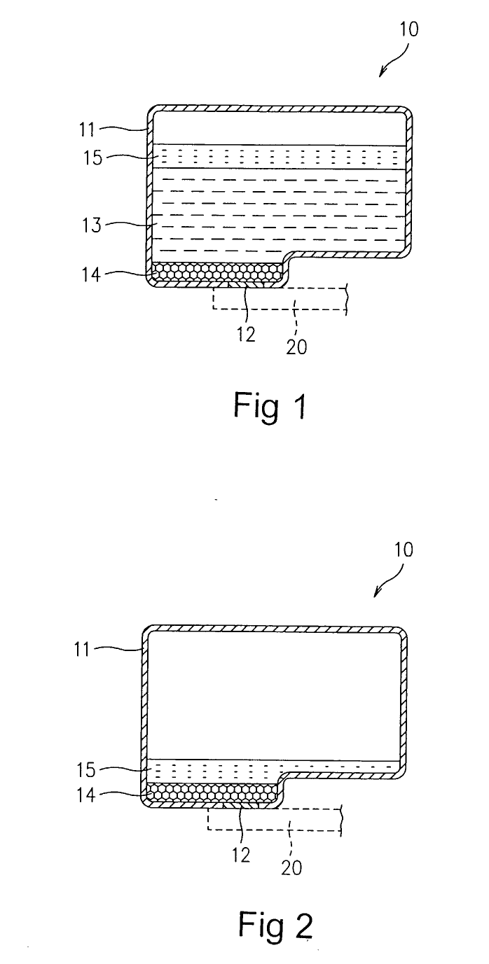

Please see FIG. 1, wherein the structure of an embodiment of this invention is shown. However, that structure is only for reference purpose and should not constitute any limitation in the application for patent.

This invention provides a device (10) that prevents the nozzle of printer from jam, which comprises of a cartridge (11) filled with ink (13) and with an ink outlet (12) contacting the nozzle (20) of printer. It features with: a liquid (e.g., a oleiferous liquid) (14) lighter than and not dissolvable in the ink (13) in the cartridge (11) and an absorbent (15) (e.g. sponge) at the outlet (12) in the said cartridge (11).

Please see FIG. 1 and FIG. 2, wherein the liquid (14), ink (13), and absorbent (15) are aligned in the cartridge (11) from bottom to top. When the ink (13) is not used up, the absorbent (15) absorbs the ink (13) and provides the ink (13) to the nozzle (20) of printer via the outlet (12). Because the liquid (14) is lighter than the ink (13) and not dissolvable in it, it stays on ink 13. When the ink (13) in cartridge 11 is used up, the absorbent (15) will absorb the liquid (14). Therefore, ink 13 will not dry and form a mess to block nozzle 12 even it is not used for long or the device (10) is not replaced in time. Furthermore, the liquid (14) can ensure that even when an alternative brand of ink is used in cartridge, the nozzle (20) will not be jammed.

Thus, when the ink in the cartridge is used up, the absorbent will absorb the liquid, which prevents both the ink from drying to congregate into a mass and the outlet from drying. Therefore, it can keep the nozzle of printer wet and unblocked. Furthermore, it can also prevent the nozzle from blocking due to the chemical combination between different brands of ink used. From above description we can see this invention can attain the intended purposes and meet all requirements for applying for a patent. According to the regulation (“Solving new problems with a existing method, or solving existing problems with a new method can be regarded as an innovation; an innovation with a new structure can be qualified for applying for a new patent, even through it is not new in principle”) of the Patent Office, I apply for a new patent with it. Above description and illustration are only for the said embodiments and should not constitute any limitation in applying for a new patent. In cases they are not suitable for confine the actual applying range of this invention, any implementation with the structure and functionality described above but some alternation in figures or equivalent components should fall in the concept of this invention.

1. A device preventing printers from jam on the jet nozzle, comprising of a cartridge filled with ink and with an ink outlet contacting the nozzle of printer; It features with: a liquid lighter than and not dissolvable in the ink in the cartridge and an absorbent at the outlet in the said cartridge; thus, when the ink in the cartridge is used up, the absorbent will absorb the liquid, which prevents both the ink from drying to congregate into a mass and the outlet from drying; therefore, it can keep the nozzle of printer wet and unblocked; furthermore, it can also prevent the nozzle from blocking due to the chemical combination between different brands of ink used.

2. The device preventing printers from jam on the jet nozzle as claim 1, wherein the liquids in the cartridge that is lighter than the ink and not dissolvable in the ink can be a oleiferous liquid.

3. The device preventing printers from jam on the jet nozzle as claim 1, wherein the absorbent can be a sponge material.

4. The device preventing printers from jam on the jet nozzle as claim 1, wherein the absorbent can be replaced to prevent the nozzle from jam due to chemical combination reactions between different brands of ink.
